(19) United States
(12) Patent Application Publication
(10) Pub. No.: US 2008/0047672 A1
(43) Pub. Date: Feb. 28, 2008

(54) GARAGE DOOR OPENER

(76) Inventors: James Gorman, Algonquin, IL (US); Theron Neeley, Crystal Lake, IL (US)

Correspondence Address: MCANDREWS HELD & MALLOY, LTD, 500 WEST MADISON STREET, SUITE 3400, CHICAGO, IL, 60661, US

(21) Appl. No.: 11/845,373

(22) Filed: Aug. 27, 2007

Related U.S. Application Data
(60) Provisional application No. 60/823,553, filed on Aug. 25, 2006.

(51) Int. Cl. E05F 15/10; A47H 33/00; E05F 15/20

(52) U.S. Cl. 160/1; 160/188; 160/405

(57) ABSTRACT

Embodiments of the present invention relate to a garage door opener in which a plurality of main rail segments are pivotably connected. The pivotable connection allows at least a portion of the main rail segments to be folded. When secured in a non-folded orientation, the plurality of main rail members form a main rail. The distal end of the main rail may be operably connected to a motor. The proximate end of a main rail may be operably attached to an adjustment system that includes a housing and an adjustment member. The housing may be operably attached to a pinion that engages at least a portion of a drive component. Manipulation of the adjustment member may move the pinion towards or away from the adjacent main rail, thereby either pulling or relaxing the engagement between the pinion and the drive component, and thus adjusting tension in the drive component.

### RELATED APPLICATIONS

This application claims the benefit of U.S. Provisional Application No. 60/823,553, filed Aug. 25, 2006, which is incorporated herein by reference in its entirety.

### BACKGROUND OF THE INVENTION

Given the size of assembled garage door openers, conventional garage door openers are typically packaged with their main rails unassembled. In the past, manufacturers wishing to pre-assemble at least a portion of the garage door opener components, such as the main rails, have been limited by the size of the opener unit packages they could ship cost-effectively. More particularly, the length of the necessary packaging may make transportation, handling, and/or storage of these openers prohibitively inconvenient and/or expensive.

The assembly of garage door openers for the end user can be costly, time consuming, and hazardous, as the user may need to manually align and connect the rail segments to one another. Further, the assembly of such main rails is often difficult for a single individual, as the size of the main rails may present challenges in keeping unattached rail segments properly aligned while attempting to connect the rails. Often, individuals installing conventional garage door openers may need the assistance of a second person to properly assemble the main rail.

For example, with a conventional garage door opener, a user attaching the first rail segment to a motor mounted on the ceiling may need a second person, on a second ladder, to hold the first rail segment steady while the user connects the first rail segment to the motor. The second person may also be needed to hold each remaining rail segment steady while the user connects them to assemble the main rail. If a second person is unavailable, it may be very difficult, and dangerous, for a user on a ladder to hold the rail segments steady while connecting them.

Additionally, if the user of a conventional opener wishes to mount the motor to the ceiling after assembling the main rail, a second person may be needed to hold the main rail in a steady position. And again, if a second person is unavailable, it may be very difficult, or even dangerous, for a user on a ladder to hold the main rail steady while mounting the motor to the garage ceiling.

Conventional garage door openers may also be packaged with at least a portion of the drive system unconnected to the main rail and motor. To install these openers, the user may manually lubricate the drive system, main rail, and motor. After lubricating these components, the user may manually thread the drive component through the main rail and the motor. This process may be complicated by the need to adjust the tension of the drive component. In particular, there may be relatively little slack in the drive component, which may increase the difficulty of properly positioning the drive component during assembly. The user may need to adjust tension controls to alter the amount of slack in the drive component, such as adjusting tension rollers, or changing the length of the drive component, for example by removing links in a drive chain. These installation steps may be dirty and/or time-consuming for the user. Moreover, if the main rail and motor have already been attached to the garage ceiling and/or walls, the user may have to perform these steps on a ladder. And any additional installation time spent on a ladder may increase the risk of a harmful fall.

### BRIEF SUMMARY OF THE INVENTION

Certain embodiments of the present invention provide a garage door opener that may include a main rail that is comprised of a plurality of pivotably connected main rail segments. The pivotable connection between the main rail segments may allow the main rail segments to be moved from a folded position to an un-folded position, and vice versa. According to embodiments of the present invention, the pivotable connection between adjacent main rail segments may be established through the use of a hinge(s).

When the main rail segments are in a folded position, the main rail segments and the motor, if attached, may be in a compact configuration. This compact configuration may allow for the main rail segments and motor to be supplied to an end user in an at least partially pre-assembled condition. The pre-existing, pivotable connections may also reduce the time needed to align and secure the main rail segments in a permanent position for operation of the garage door opener.

Further, the pre-assembled condition may include pre-installing the drive system. The drive system may include a drive component, such as a chain or belt, that is operably connected to a motor, and a pinion, which may engage the drive component. The drive component may travel in a looped path that includes traveling along at least a portion of the main rail. Pre-assembling the drive component may further make the installation process faster and/or simplified.

The pivotably connected main rail segments may be secured in a non-folded position through the use of mechanical fasteners. For example, according to embodiments of the present invention, a locking plate(s) may be operably fastened to at least one main rail segment, for example through the use of bolts and nuts, so as to prevent that main rail segment and an adjacent rail segment from being moved from an non-folded to a folded position.

The garage door opener may also include an adjustment system for adjusting the tension or slack in the drive component. The adjustment system may include an adjustment member and a housing. According to an embodiment of the present invention, the adjustment member may be operably connected to both the housing and a flange on the proximate end of the main rail. Further, the adjustment system may be operably connected to a garage wall. The housing may be operably connected to the pinion.

The manipulation of the adjustment member may cause the housing, and attached pinion, to move towards or away from the main rail. When the pinion is moved closer to the main rail, the tension in the drive component may be reduced, thereby providing additional slack in the drive component. Conversely, when the pinion is moved away from the main rail, the tension in the drive component may be increased, which may reduced and/or eliminate slack in the drive component.

### BRIEF DESCRIPTION OF SEVERAL VIEWS OF THE DRAWINGS

FIG. 1 illustrates a perspective view of a garage door opener according to an embodiment of the present invention operating within a garage door system according to an embodiment of the present invention.

FIG. 2 illustrates a cross-sectional view of a main rail according to an embodiment of the present invention.

FIG. 3 illustrates a garage door opener prior to installation according to an embodiment of the present invention.

FIG. 4 illustrates a folding and locking system according to an embodiment of the present invention.

FIG. 5 illustrates a perspective view of a pinion and a portion of a drive component of a drive system according to an embodiment of the present invention.

FIG. 6 illustrates a close-up view of an adjustment system, along with a portion of the drive system and the three main rail segments according to an embodiment of the present invention.

FIG. 7 illustrates a method for installing the garage door opener on an exemplary garage door system according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

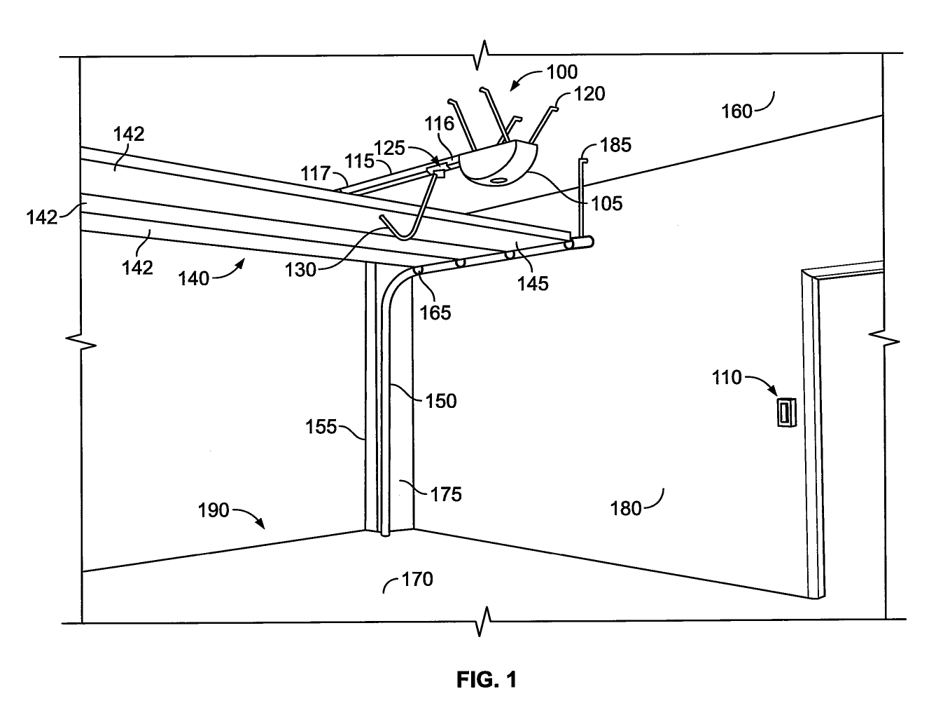

FIG. 1 illustrates a perspective view of a garage door opener 100 operating within a garage door system 140 for opening and closing an entryway 155 of a housing according to an embodiment of the present invention. For purposes of illustration, the housing may be a garage 190 that includes an entryway 155, a ceiling 160, a floor 170, a front wall 175, a first sidewall 180, and a second sidewall. However, according to other embodiments, the housing may be a variety of other structures, including, but not limited to, a warehouse, manufacturing facility, shed, storage facility, store, loading dock, restaurant, or an automotive repair center, among others. Further, at least a portion of the entryway 155 may or may not be covered. For example, according to certain embodiments of the present invention, the entryway may include a door and/or a window.

The garage door system 140 may include a garage door 145 that is moveable between a closed and an opened positioned over the entryway 155, a track 150, a plurality of rollers or wheels 165, a track support member 185, and a garage door spring. The track 150 may include a generally horizontal and a vertical portion that are operably connected to each other. At least a portion of the track 150 may be operably connected to the floor 170. The vertical portion of track 150 may be operably connected to a bordering wall in the garage 190, for example the front sidewall 175. The horizontal portion of the track 150 may be rigidly connected to a bordering wall in the garage 190 and/or the ceiling 160, through the use of track support members 185 and/or fasteners.

The garage door 145 may be composed of a plurality of garage door panels 142 that are rotatably connected by hinge components. However, according to other embodiments, the garage door 145 may be a gate or gate panels. The sides of at least a portion of the panels 142 may be operably connected to the center axels of the wheels 165.

During operation, the wheels 165 may roll or slide against or along at least a portion of the track 150, thereby allowing the garage door 145 to move from a horizontal, open position to a vertical, closed position, over at least a portion of the entryway 155, and vice versa. Further, as the garage door 145 travels along the generally straight and curved portions of the track 150 while moving between open and closed positions, the hinged connection between the panels 142 may allow the panels 142 to rotate or pivot.

The garage door opener 100 may include a motor 105, a door activating switch 110, a main rail 115, at least one motor support member 120, a trolley component 125, a connector 130, and a drive system. As discussed below in more detail, the drive system may include a drive component a pinion. For example, in embodiments in which the drive system is a chain drive, the drive component may be a chain that is operably connected to the motor 105, while the pinion may be a gear or a sprocket. Conversely, in instances in which the drive system is a belt drive, the drive component may be a belt, and the pinion may be a pulley or a sheave, among others. In another embodiment, the drive system may be screw driven, where a motor may turn a threaded stud that is attached to a hinge system that raises and lowers the door.

As shown in FIG. 1, the motor 105 may be operably connected to the ceiling 160 by at least one motor support member 120. The number of motor support members 120 used to secure the motor 105 may be influenced by a number of different factors, including the size of the motor 105 and the configuration of the motor support member(s) 120, among others.

In one embodiment, the motor 105 may be operably connected to a power cord that includes a connector that is configured to be plugged into an electrical outlet in the garage 190, such as an outlet positioned on the ceiling 160. Alternatively, rather than being plugged into an outlet, the motor 105 may be wired for a direct connection with the electrical wiring of the garage 190 or a circuit that may provide electrical power to the motor 105. In another embodiment, the motor 105 may be battery powered. Alternatively, the motor 105 may be replaced with a manual system that may allow an individual to apply the physical force necessary to operate the garage door opener 100. For example, the manual system may include mechanical components that allow a user to apply force, such as cranks, ropes, handles, and/or belts. The manual system may also include components to transfer this force to the drive system 505, such as gears and/or pulleys.

Although FIG. 1 illustrates a door activating switch 110 connected to an interior wall of the garage 190, certain embodiments of the present invention may provide for a different number of door activating switches 110 that may be mounted at different locations, be portable, or be a combination thereof. For example, door activating switches 110 may be operably mounted, such as through the use of fasteners or adhesives, on the internal and/or external walls of the garage 190. Moreover, one or more door activating switches 110 may be positioned on surfaces of other structures connected to the garage 190, or in close proximity to the garage 190, such as houses and/or sheds. Further, door activating switches 110 that are mounted on the exterior walls of the garage 190 or other adjacent structures may be housed in a weather-proof case.

According to embodiments of the present invention, a wall mounted door activating switch 110 may receive electrical power through an electrical connection to the motor 105. For example, electrical wires may operably connect the wall mounted door activating switch 100 to the motor 105. Alternatively, the door activating switch 110 may have an electrical power source that is independent of the motor 105. For example, the door activating switch 110 may be equipped with an electrical plug for a direct connection to one of the electrical outlets in the garage 190, or may be wired to a electrical supply or circuit in the garage 190. As another example, the door activating switch 110 may be powered by a battery, such as alkaline batteries, nickel metal hydride batteries, and/or lithium batteries, among others. Further, these batteries may be rechargeable and/or non-rechargeable.

In order to transmit activation signals, the door activating switch 110 may be wired directly to the motor 105. Alternatively, the door activating switch 110 may contain a transmitter capable of sending wireless signals directly to a receiver that is operably connected to the motor 105. The wired and/or wireless connection between the door activating switch 110 and the motor 105 enables the user to activate the motor 105 in order to raise or lower the garage door 145 across the entryway 155.

The main rail 115 may include a distal end 116 and a proximate end 117. The distal end 116 of the main rail 115 may be operably connected to the motor 105. For example, the distal end 116 of the main rail 115 may be rigidly connected to motor 105 through the use of mechanical fasteners, including, but not limited to, a bolt(s) and nut(s) connection or pins, among others. The proximate end 117 of the main rail 115 may be attached to an adjustment system, as discussed in more detail below. Further, the main rail 115 may be aligned to have an generally horizontal orientation.

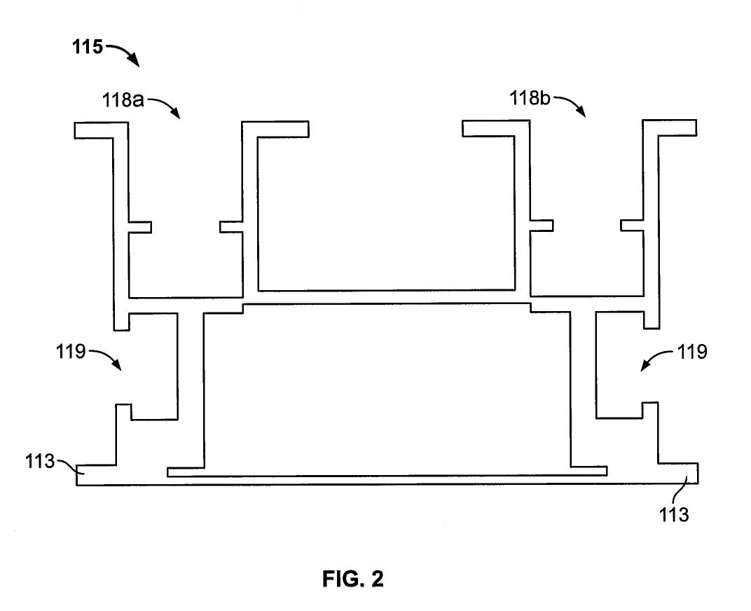

FIG. 2 illustrates a cross-sectional view of a main rail 115 according to an embodiment of the present invention. The main rail 115 may include a plurality of internal drive channels 118a, 118b and a plurality of trolley channels 119. In accordance with the embodiment illustrated in FIG. 2, the main rail 115 may include two drive channels 118a, 118b that may run generally parallel to each other along at least a portion of the length of the main rail 115. The drive channels 118a, 118b may be vertical channels where the drive system is operably connected to or resides at least partially within. That is, according to embodiments of the present invention, when the opener 100 is not in use, the drive system may rest in the drive channels 118a, 118b. When the opener 100 is activated, the drive component of the drive system may slide along and within at least a portion of the drive channels 118a, 118b. Additionally, two trolley channels 119 may run parallel to one another along the outer, generally vertical surfaces of the main rail 115. The trolley channels 119 may be recessed into at least a portion of the main rail 115, as illustrated in FIG. 2. Alternatively, at least a portion of the trolley channel 119, or may be along the outer ledges 113 of the main rail 115. Further, the position of the drive channels 118 and the trolley channels 119 may be different from those illustrated in FIG. 2. For example, the main rail 115 may be manufactured so that the trolley channels 119 and the drive channels 118 are in positions opposite from those shown by FIG. 2.

The main rail 115 may be configured to reduce the potential for friction and/or wear of the trolley component 125 and the drive component of the drive system that may result from contact with the main rail 115. For example, the drive channels 118a, 118b and the trolley channels 119 may be sized for no or minimal contact with the drive component and the trolley component 125, respectively. Further, the main rail 115 may include rounded, beveled, and/or or chamfered corners and edges. Such shapes may reduce friction and/or wear at the connection between the main rail 115 and the trolley component 125. Similarly, these alternative shapes may reduce friction and/or wear at the connection between the main rail 115 and the drive component, such as a chain or belt drive, of the drive system.

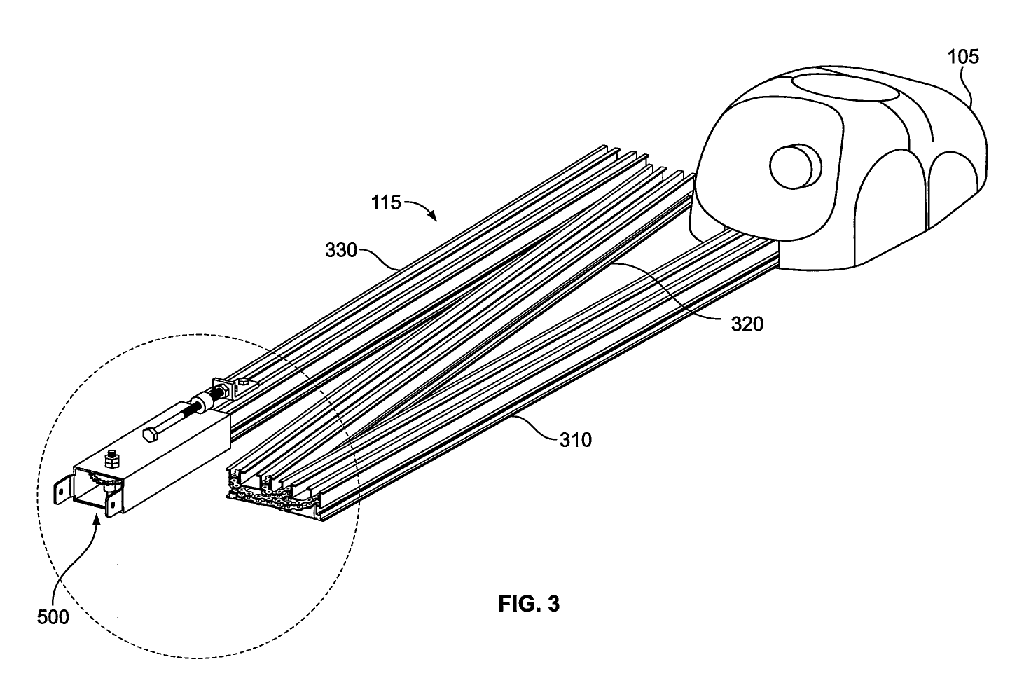

FIG. 3 illustrates a main rail 115 that includes a plurality of folded main rail segments 310, 320, 330 and an adjustment system 500 prior to installation according to an embodiment of the present invention. Although FIG. 3 illustrates three folded main rail segments 310, 320, 330, certain embodiments of the present invention may provide for a different number foldable rail segments. Moreover, the number of rail segments 310, 320, 330 may be at least partially dependent on the needed length of the assembled main rail 115 and/or the lengths of each rail segment 310, 320, 330. Additionally, each rail segment 310, 320, 330 may or may not have the same length. When folded, the main rail segments 310, 320, 330 may assist in providing the garage door opener 100 with a relatively compact configuration. After installation is complete, the main rail segments 310, 320, 330 comprise the non-folded main rail 115.

The motor 105 may be operably connected to the adjacent end of the first main rail segment 310. The opposite end of the first main rail segment 310 may be pivotally coupled to one end of a second main rail segment 320. That is, a pivotable connection between the first and second main rail segments 310, 320 may allow the first and second main rail segments 310, 320 to pivot and rotate with respect to one another, as discussed below in more detail. Similarly, the opposite end of the second main rail segment 320 may be pivotally coupled to the third main rail segment 330.

The pivotal connections between the main rail segments 310, 320, 330 may allow the main rail 115 to be kept in a folded or collapsed position, as shown in FIG. 3, during packaging, shipping and/or the installation process. FIG. 1 illustrates the main rail 115 after installation in its non-folded position for operation of a garage door opener 100 according to an embodiment of the present invention.

One end of the third main rail segment 330 may be movably connected to the adjustment system 500. In one embodiment, the adjustment system 500 may move forward or backward along at least a portion of the length of the third main rail segment 330 in order to reduce or increase slack in the drive component. Alternatively, at least a portion of the adjustment system 500 may move toward or away from the adjacent end of the third rail segment 330.

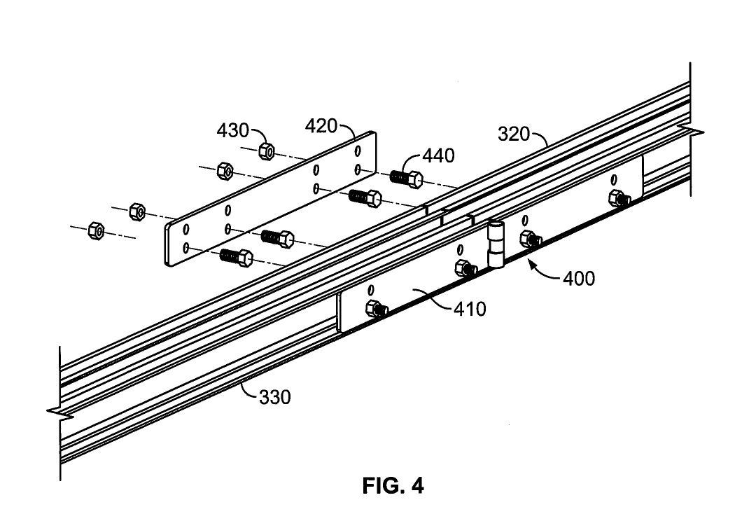

FIG. 4 illustrates a folding and locking system 400 according to an embodiment of the present invention. The folding and locking system 400 may include a hinge 410 and a locking plate 420 that are mechanically secured to at least one main rail segment 310, 320, 330. For example, in the embodiment illustrated in FIG. 4, the hinge 410 and locking plate 420 are secured to the second and third main rail segments 320, 330 through the use of nuts 430 and bolts 440. Further, according to one embodiment, the locking plate 420 and/or the hinge 410 may fit within the trolley channel 119.

The hinge 410 may pivotably couple main rail segments 320, 330 together. For example, the hinge 410 may be connected to one end of the second and third main rail segments 320, 330, thereby allowing the second and third rail segments 320, 330 to pivot and rotate with respect to one another around the center axis of the hinge 410.

In operation, when the second and third rail segments are connected to the hinge 410, and in a folded position, one of the rail segments 320, 330 may be pivoted to a non-folded orientation with respect to the other main rail segment 320, 330, as shown in FIG. 4. The second and third rail segments 320, 330 may then be locked into this non-folded orientation by connecting the locking plate 420 to the second and/or third rail segments 320, 330 with nuts 430 and bolts 440. Likewise, when the first and second main rail segments 310, 320 are foldably connected by a hinge 410, either of the main rail segments 310, 320 may be pivoted so that the rail segments 310, 320 are, with respect to each other, in a non-folded orientation. The first and second main rail segments may then be secured in the non-folded orientation by connecting a locking plate 420 to the first and/or second rail segments 310, 320. Depending on the order of installation of the garage door opener 100, after all main rail segments 310, 320, 330 are locked into a non-folded orientation, the main rail 115 may be in position for operation of the garage door opener 100.

In an alternative embodiment, the locking plate 420 may be rigidly connected to the main rail segments 310, 320, 330 by other fasteners, such as screws, nails, rivets, and/or adhesives. Further, in certain embodiments of the present invention, the main rail segments 310, 320, 330 may be pivotally coupled to allow for vertical rotation, as opposed to the embodiment illustrated in FIG. 4, where the main rail segments 310, 320, 330 are pivotally coupled to allow for horizontal rotation. The main rail segments 310, 320, 330 may also be folded on top of one another prior to installation, rather than being folded next to one another as illustrated in FIG. 3. The manufacturer and/or the user may attach hinges 410 to either the top or bottom of the main rail segments 310, 320, 330. Similarly, the manufacturer and/or the user may attach locking plates 420 on the opposite side of the main rail segments 310, 320, 330 with respect to the hinges 410.

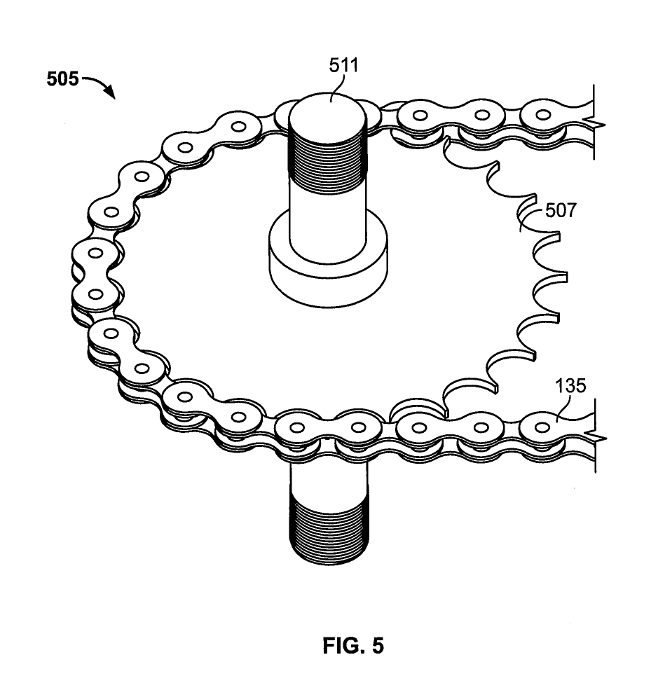

FIG. 5 illustrates a perspective view of a pinion 507 and a portion of a drive component 135 of a drive system 505 according to an embodiment of the present invention. As shown in FIG. 5, according to embodiments of the present invention, the drive system 505 may be a chain drive, wherein the drive component 135 is a chain, and the pinion 507 may be a gear or sprocket. However, as previously discussed, the drive system 505 may utilize other types of drive systems, including belt drives and screw drives.

The main rail 115 and the motor 105 are operably connected to the drive system 505. The operable connection between the main rail 115 and the drive component is made such that when the motor 105 is activated, the drive component 135 is moved in a path around the motor 105, the pinion 507, and the main rail 115.

The pinion 507 may be operably connected to shaft or axel 511. According to one embodiment, the pinion 507 may rotate around the axel 511. In such an embodiment, the pinion 507 may include a bore having a diameter larger than that of the adjacent portion of the axel 511, which thereby allows for the pinion 507 to rotate about the axel 511. In another embodiment, the axel 511 may be operably connected to a bearing, the outer diameter of the bearing mating with a bore or counter bore in the pinion 507, and which assists in the rotation of the pinion 507 about the axel 511. Alternatively, the axel 511 and the pinion 507 may rotate together. For example, the axel 511 and pinion 507 may be operably connected to each other, such as through the use of a set screw, pin, key, or spline connection, among others. Alternatively, the pinion 507 and axel 511 may have a unitary structure.

The pinion 507 may be configured to operably engage the drive component 135 of the drive system 505. For example, in embodiments in which the drive component 135 is a chain drive, the pinion 507 may include teeth that engage surfaces of the chain, and which assist in guiding the chain along a looped path through the main rail 115 and the motor 105. Alternatively, the pinion 507 may have a generally cylindrical configuration that allows the drive component 135 to move with or against the pinion 507.

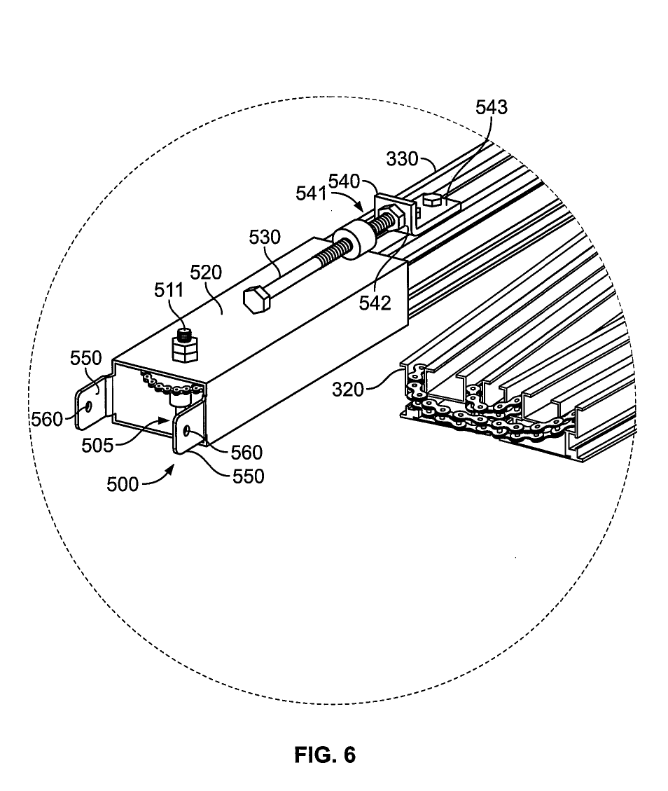

FIG. 6 illustrates a close-up view of an adjustment system 500, along with a portion of the drive system 505 and the three main rail segments 310, 320, 330 according to an embodiment of the present invention. The adjustment system 500 may include a housing 520, an adjustment member 530, a lock-down stop assembly, two flanges 550, and two attachment holes 560. The housing 520 may be operably connected to the pinion 507 of the drive system 505.

In the embodiment illustrated in FIG. 6, the axel 511 may be operably connected to the housing 520 by fasteners, such as nuts or pins, for example. Further, the pinion 507 may be positioned to be centered between the drive channels 118a, 118b of the main rail 115

In the illustrated embodiment, the adjustment member 530 may be operably connected to the housing 520 and may mate or be operably connected to a lock-down stop assembly 541. The adjustment member 520 may include, but is not limited to, a bolt or screw, among others.

The adjustment member 530 may be rotatably connected to the top of the housing 520. That is, the adjustment member 530 may be rotated while still remaining connected to the housing 520. Since the adjustment member 530 is rotatably connected to both the housing 520 and the lock-down stop assembly 541, rotation of the adjustment member 530 moves the housing 520 towards or away from lock-down stop assembly 541, depending on the direction of rotation.

In the embodiment illustrate in FIG. 6, the lock-down stop assembly may include a flange 540 having a vertical portion 542 and a horizontal portion 543. The horizontal portion 543 of the flange 540 may be connected to the proximate end 117 of the main rail 115. For example, in the embodiment illustrated in FIG. 6, the horizontal portion 543 may be connected to the upper surface of the third main rail segment 330, such as through the use of a mechanical fastener, weld, or adhesive. Alternatively, the flange 540 may be an integral part of the third rail segment 330. However, in other embodiments, the adjustment system 500 may be attached to the third rail segment 330 in a different position than that illustrated in FIG. 6. For example, the adjustment system 500 may be attached to the third rail segment 330 in a position inverted from the position shown in FIG. 6, or on either side of the rail segment 330.

The vertical portion 542 of the flange 540 may include an orifice through which at least a portion of the adjustment member 530 may pass. The adjustment member 530 may be secured to the flange 540 through the use of a fastener, such as a mating nut, among others. For example, when the adjustment member 530 is rotated, it may move through a lock-down stop assembly 541, which may include a nut and the vertical portion 542 of the flange 540. Alternatively, the flange 540 may include a threaded aperture that mates a threaded portion of the adjustment member 530.

The operable connection between the housing 520 and the adjustment member 530, may allow for the housing 520, and the operably connected pinion 507, to be moved towards or away from the mail rail segment 330. Moreover, the movement of the pinion 507 relative to the main rail 115 may tighten or loosen the operable connection between the pinion 507 and the drive component 135. Accordingly, when the pinion is moved away from the proximate end 117 of the mail rail 115, the tension in the connection between the pinion 507 and the drive component 135 may be increased. Conversely, when the pinion is moved toward the mail rail 115, the tension in the connection between the pinion 507 and the drive component 135 may be decreased, which may increase the slack in the drive component 135.

Two attachment holes 560 may be provided by two vertical flanges 550 that extend from one end of the housing 520. The vertical flanges 550 and the attachment holes 560 are used to secure a connection between the adjustment unit 500 and a wall in the garage 190. For example, the flanges 550 and the attachment holes 560 may be used in conjunction with fasteners, such as nails, screws, nuts and bolts, and/or rivets, to secure the adjustment system 500 to a wall in the garage 190. This connection may provide added stability and support to the main rail 115 during operation of the garage door opener 100. However, in other embodiments of the present invention, the flanges 550 may extend from different positions on the housing 520. For example, the flanges 550 may extend from the horizontal edges of the housing 520, rather than from the vertical edges of the housing 520.

The trolley component 125 may be movably connected to the main rail 115 at the plurality of trolley channels 119 that run along at least a portion of the length of the main rail 115. For example, as previously discussed, according to one embodiment, a trolley channel 119 is provided on both sides of the main rail 115. Accordingly, both sides of the trolley component 125 may include sliding devices, such as wheels, which engage the trolley channels 119. Further, the trolley component 125 may be operably connected to the drive system 505. That is, when the drive component 135 moves, the trolley component 125 may be pulled along at least a portion of the main rail 115.

The connector 130 may be rotatably connected to the bottom of the trolley component 125. The bottom of the rigid connector 130 may be rotatably connected to the garage door 145. According as the trolley component 125 slides along the main rail 115, the connector 130 may rotate in a vertical plane. That is, the rigid connector 130 may rotate as it pulls the garage door 145 into its horizontal, open position or its vertical, closed position along the track 150.

In operation, when the user activates the door activating switch 110, a signal is transmitted to the motor 105. This signal activates the motor 105, which moves the drive component 135 along the looped path of the main rail 115. The movement of the drive component 135 along the main rail 115 slides the trolley component 125 along the main rail 115. When trolley component 125 moves, the connector 130 pivots at its connections with the trolley component 125 and the garage door 145. The trolley component 125 pulls the rigid connector 130 and the garage door 145 along the path of track 150. If the garage door 145 was initially in the horizontal, open position, the garage door 145 may come to rest in the vertical, closed position. Similarly, if the garage door 145 was in the closed position initially, it may come to rest in the horizontal, open position.

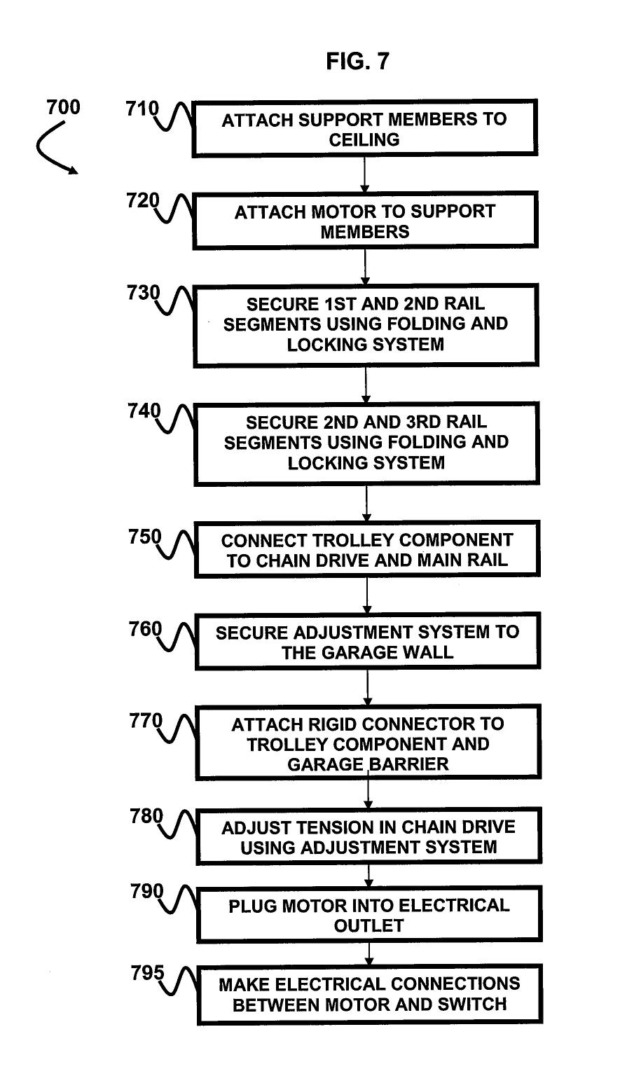

FIG. 7 illustrates a method 700 for installing the garage door opener 100 on an exemplary garage door system 140 according to an embodiment of the present invention. This method 700 includes the following steps, described below in more detail. At step 710, a user may attach the at least one motor support member 120 to the ceiling 160 of the garage 190. At step 720, the user attaches the motor 105 to the motor support members 120. At step 730, the user may pivot the first and second main rail segments 310 and 320 into a non-folded orientation, and secures their position using a folding and locking system 400. At step 740, the user may pivot the second and third main rail segments 320 and 330 into a non-folded orientation and secures their position using a folding and locking system 400. At step 750, the may user connect the trolley component 125 to the integrated drive system 505 and the main rail 115. At step 760, the user may secure the adjustment system 500 to the garage 190 wall. At step 770, the user may connect the connector 130 to the trolley component 125 and to the garage door 145. At step 780, the user may adjust the amount of tension in the drive component 135 using the adjustment system 500. At step 790, the user may connect the motor 105 into an electrical source, for example plugging a power cord for the motor 105 into an outlet on the ceiling 160 of the garage 190. At step 795, the user may mount the door activating switch 110 to a wall and set up a wired connection between the motor 105 and the door activating switch 110. The method 700 is described with reference to the elements of the garage door opener 100 described above, but it should be understood that other implementations are possible.

At step 710, the user may un-package the garage door opener 100 in the configuration shown in FIG. 2. The user may climb a ladder to attach the motor support members 120 to the ceiling 160 using fasteners, such as screws, nails, and/or nuts and bolts. Either before or after these motor support members 120 are attached, the user may invert the garage door opener 100 for attachment to the ceiling 160 of the garage 190. If the motor 105 and the first main rail segment 310 were not previously connected or completely secured, for example by the manufacturer or distributor, the user may make this connection.

At step 720, after the motor support members 120 are attached to the ceiling 160 and the garage door opener 100 is flipped into the correct position, the user may attach the motor 105 to the motor support members 120 using fasteners, such as screws, nails, rivets, and/or nuts and bolts. Once these motor support members 120 are secured to the motor 105, the garage door opener 100 may be self-supported, and the user may not need to exert physical force to keep the motor 105 from falling. Further, the connection between the motor 105 and the first main rail segment 310 may be sufficient to support the weight of the other pivotally coupled main rail segments 320, 330, such that the user may not need to physical exert force to keep the main rail segments 310, 320, 330 from falling.

At step 730, the user may position a ladder directly underneath the hinge 410 at the joint between the first and second main rail segments 310, 320. Once in position, the user may pivot the second main rail segment 320 into a non-folded orientation with respect to the first main rail segment 310. After positioning the first and second main rail segments 310, 320 in a non-folded orientation, the user may secure a locking plate 420 to the first and second main rain segments 310, 320 with nuts 430 and bolts 440. The rigid connection created by the locking plate 420 may be sufficient to support the weight of the second and third main rail segments 320, 330, such that the user may not need to exert force to keep the main rail segments 320, 330 from falling.

At step 740, the user may position a ladder directly underneath the hinge 410 at the joint between the second and third main rail segments 320, 330. Once in position, the user may pivot the third main rail segment 330 into a non-folded orientation with respect to the second main rail segment 320. After positioning the second and third main rail segments 320, 330 in a non-folded orientation, the user may secure a locking plate 420 to the second and third main rail segments 320, 330 with nuts 430 and bolts 440. Once the locking plate 420 is secured, the main rail 115 may be completely assembled. The rigid connections created by the two locking plates 420 may be sufficient to support the weight of the main rail 115, such that the user may not need to exert force to keep the main rail 115 from falling.

At step 750, the user may slide the trolley component 125 onto the trolley channels 119 of the main rail 115. After the trolley component 125 is connected to the main rail 115, the trolley component 125 may be connected to the drive component 135.

At step 760, the adjustment system 500 may be affixed to a wall in the garage 190. This may be accomplished by using fasteners, such as nails, screws, nuts and bolts, and/or rivets through attachment holes 560.

At step 770, the user may connect the rigid connector 130 to the trolley component 125 and to the garage door 145. These connections may be made with rotational connection pieces, such as hinges and/or ball joints, and fasteners, such as nails, screws, rivets, and/or nuts and bolts.

At step 780, the user may rotate the adjustment member 330 to take any excess slack out of the drive component 135. Rotating the adjustment member 330 increases the tension in the drive component 135 and may result in smoother operation of the garage door opener 100.

At step 790, the motor 105 may be plugged into an electrical outlet on ceiling 160. However, as previously discussed, the motor 105 may be operably connected to an electrical power supply or source through a variety of different connections.

At step 795, the user may affix the door activating switch 110 onto the garage 190 wall 180 using fasteners, such as nails, screws, nuts and bolts, and/or adhesives. A wiring connection may be made between the motor 105 and the door activating switch 110. If a hard-wired door activating switch 110 is used, a signal wire connection may be made between the motor 105 and the door activating switch 110. If a wireless wall switch is used, a signal wire connection need not be made between the motor 105 and the door activating switch 110. Alternatively, as previously discussed, the door activation switch 110 may be a portable or wireless device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A garage door opener comprising:
a motor;
a plurality of main rail segments, at least two of the plurality of main rail segments being pivotably connected the pivotably connected main rail segments to be operably moved from a folded orientation to a non-folded position, at least one of the plurality of main rail segments being operably connected to the motor, each of the plurality of main rail segments being oriented into non-folded positions to form a mail rail;
a drive system, the drive system including a drive component and a pinion, the drive component being operably connected to the motor and the pinion; and
an adjustment system, the adjustment system including a housing and an adjustment member, the housing being operably connected to the pinion, the adjustment system being configured to adjust the tension in the drive component.

2. The garage door opener of claim 1 wherein the main rail includes at least one drive channel and at least one trolley channel, the at least one drive channel configured to allow the movement of the drive component along at least a portion of the main rail, the at least one trolley channel configured to be operably engaged by a trolley component, the trolley component being movably connected to the main rail at the at least one trolley channel, the trolley component being operably connected to the drive component.

3. The invention of claim 2 further including a connector, the connector having a first end and a second end, the first being pivotably connected to a the trolley component, the second end being pivotably connected to a garage door.

4. The garage door opener of claim 1 wherein the adjustment system further includes a lock-down stop assembly, the a lock-down stop assembly including a flange, the flange being operably connected to an adjacent main rail segment, the flange being configured to receive the rotatable insertion of at least a portion of the adjustment member.

5. The garage door opener of claim 1 wherein the adjustment system is operably connected to a wall in a garage.

6. The garage door opener of claim 1 wherein the drive system is a chain drive.

7. The garage door opener of claim 1 wherein the drive system is a belt drive.

8. The garage door opener of claim 1 wherein a hinge pivotably connects at least two of the plurality of main rail segments.

9. The garage door opener of claim 1 wherein at least two of the plurality of main rail segments are secured in a non-folded orientation by a locking plate.

10. The invention of claim 1 further including a door activating switch, the door activating switch configured to transmit and activation signal to the motor to commence operation of the motor.

11. A garage door opener comprising:
a motor;
a plurality of main rail segments, the plurality of main rail segments having at least one drive channel and at least one trolley channel, at least two of the plurality of main rail segments being pivotably connected to allow the pivotably connected main rail segments to be pivoted from a folded orientation to a non-folded orientation, a locking plate being operably attached to at least one of the pivotably connected main rail segments to secure the pivotably connected main rail segments in a non-folded orientation, the non-folded orientation of the plurality of main rail segments forming a mail rail, the main rail having a distal end and a proximate end, the proximate end being operably connected to the motor;
a drive system, the drive system including a drive component and a pinion, the drive component being operably connected to the motor and the pinion;
a trolley component, the trolley component being movably connected to the at least one trolley channel and the drive component; and
an adjustment system, the adjustment system including a housing and an adjustment member, the pinion being operably connected to the housing, the adjustment system being operably connected to the main rail, the adjustment system being configured to adjust the tension in the drive component.

12. The garage door opener of claim 11 wherein the drive system is a chain drive.

13. The garage door opener of claim 11 wherein the drive system is screw driven.

14. The garage door opener of claim 11 wherein the drive systems is a belt drive.

15. The garage door opener of claim 11 wherein the adjustment system is operably connected to a wall in a garage.

16. A method for installing a garage door opener comprising:
attaching at least one motor support member to a housing;
attaching a motor to the at least one motor support member;
pivoting at least one main rail segment of a plurality of main rail segments from a folded orientation to a non-folded orientation with respect to an adjacent main rail segment; and
securing the pivoted main rail segment to an adjacent main rail segment in a non-folded orientation, the non-folded orientation of the plurality of main rail segments forming a main rail, the main rail having a distal end and a proximate end.

17. The method of claim 16 further including the step of securing an adjustment system to a garage wall, the adjustment system being operably connected to the proximate end of the main rail, the adjustment system including a housing and an adjustment member, the adjustment member being operably connected to the housing and the proximate end of the main rail.

18. The method of claim 17 further including the step of adjusting the tension of a drive component, the drive component being operably connected to the motor and a pinion, the pinion being operably connected to the housing, the tension in the drive component being adjusted by moving the position of the pinion toward or away from the proximate end of the main rail.

19. The method of claim 18 further including the step of connecting a trolley component to a drive system, the trolley component being configured to travel along at least a portion of the main rail, the trolley being pivotably connected to a first end of a connector, a second end of the connector being pivotably connected to a garage door.

20. The method of claim 19 further including communicating an activation signal from a door activating switch to the motor to commence operation of the motor.
